(19) United States
(12) Patent Application Publication
(10) Pub. No.: US 2012/0084244 A1
(43) Pub. Date: Apr. 5, 2012

(54) CLAIMS ISSUANCE RULE GENERATION PIPELINE

(75) Inventors: Caleb G. Baker, Seattle, WA (US); Seng Lin Shee, Redmond, WA (US); Jan Lyk Choo, Seattle, WA (US); Marcelo A. Mas, Kirkland, WA (US); Krishnanand K. Shenoy, Bothell, WA (US); Samuel R. Devasahayam, Kirkland, WA (US)

(73) Assignee: MICROSOFT CORPORATION, Redmond, WA (US)

(21) Appl. No.: 12/895,647

(22) Filed: Sep. 30, 2010

(51) Int. Cl. G06N 5/02

(52) U.S. Cl. 706/47

(57) ABSTRACT

A pipeline that includes at least an initialization stage, a processing stage, and a publication stage. The initialization stage acquires a set of globally sourced claims that can be used by any issuance statement. The processing stage manipulates a set of one or more user task specific claims that are derived from the set of one or more globally source claims. The set of one or more user task specific claims are manipulated by generating a set of one or more temporary claims. The processing stage generates the set of one or more temporary claims by applying issuance statements to the set of one or more user task specific claims. A publication stage then issues the set of one or more temporary claim in an issuance format.

### BACKGROUND

In computer programming, a “claim” includes a declaration made by an entity (often referred to as an issuer). A declaration is a statement or assertion about an entity (often referred to as a subject). Examples of entities include name, identity, key, group, privilege, capability, and others. For instance, if the subject were a person, the assertion might be that the subject is of a particular age, has a particular country of citizenship, is authorized to act in a certain role (e.g., IT administrator), or any one of many other types of assertions.

Applications may be claims-based in that they may use claims to perform processing. In doing so, after deployment, the application will encounter any number of claims made by one or more issuers. For each claim, the application (or a subsystem acting on behalf of the application) determines whether or not the application trusts the issuer to be making the assertion of the type made in the claim. If the application determines that the issuer is to be trusted, at least within the context of the assertion being made, the application will typically act as though the statement about the subject is true. Otherwise, the application will typically treat the statement about the subject as being unverified. As an example, claims have been used by applications to authenticate, control access to resources, and/or to personalize processing for a particular client machine or user. For instance, to personalize processing for a particular user, a claim may be made about the user, where the user is the subject of the claim.

One problem that arises in claims based authentication systems is the need to author and manipulate the criteria under which claims are issued. These criterion commonly known as “issuance rules” and collectively referred to as “issuance policy”, are not syntactically bound by any standard or code which results in difficulty in the comprehension of many issuance rule implementations. The dependencies and relationships between rules are often obscure. This hinders the manipulation of individual rules because it becomes unclear how this impacts on the overall policy.

### BRIEF SUMMARY

At least one embodiment described herein relates to the use of a pipeline to process claims. In computer programming, a “claim” includes a data structure that includes a declaration made by an entity (often referred to as an issuer). A declaration is a statement or assertion about an entity (often referred to as a subject).

The pipeline includes at least an initialization stage, a processing stage, and a publication stage. The initialization stage acquires a set of globally sourced claims that can be used by any issuance statement. The processing stage manipulates a set of one or more user task specific claims that are derived from the set of one or more globally source claims. The set of one or more user task specific claims are manipulated by generating a set of one or more temporary claims. The processing stage generates the set of one or more temporary claims by applying issuance rules to the set of one or more user task specific claims. A publication stage then issues the set of one or more temporary claim in an issuance format.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a pipeline that may be implemented in a computing environment in order to formulate claims in a desired output format;

FIG. 3 illustrates a flowchart of a method for formulating claims in a desired output format using the pipeline of FIG. 2; and

FIG. 4 illustrates an example user interface that may be used in the pipeline of FIG. 2 in order to allow a user to specify issuance policy using natural language.

### DETAILED DESCRIPTION

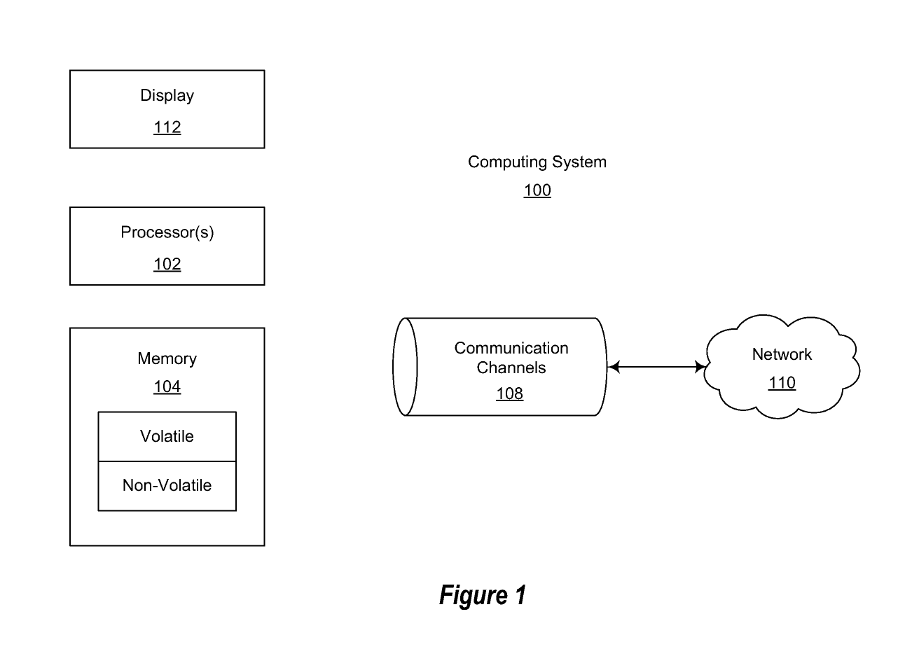

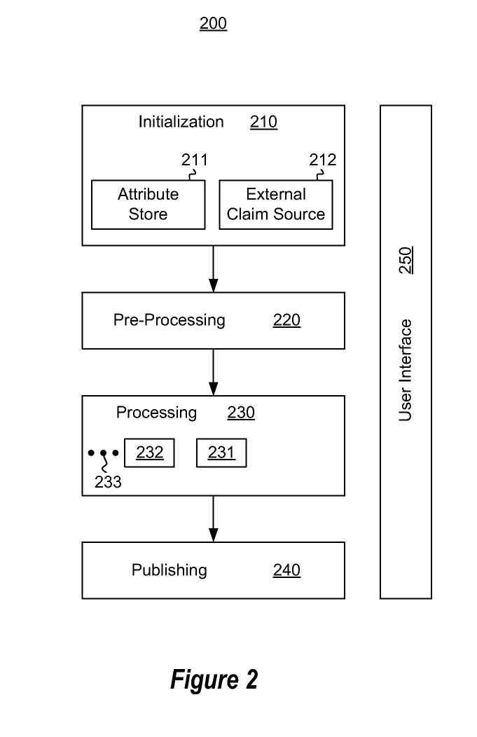

In accordance with embodiments described herein, a claim processing pipeline includes at least an initialization stage, a processing stage, and a publication stage. The initialization stage acquires a set of globally sourced claims that can be used by any issuance statement. The processing stage manipulates a set of one or more user task specific claims that are derived from the set of one or more globally source claims. The set of one or more user task specific claims are manipulated by generating a set of one or more temporary claims. The processing stage generates the set of one or more temporary claims by applying issuance rules to the set of one or more user task specific claims. A publication stage then issues the set of one or more temporary claim in an issuance format. First, some introductory discussion regarding computing systems will be described with respect to FIG. 1. Then, the embodiments of the pipeline will be described with respect to FIGS. 2 through 4.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 may also have a display 112.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a claim processing pipeline 200. The processing pipeline includes an initialization stage 210, a pre-processing stage 220, a processing stage 230, and a publication stage 240. In computer programming, a “claim” is a data structure that includes a declaration made by an entity (often referred to as an issuer). A declaration is a statement or assertion about an entity (often referred to as a subject). For instance, a declaration may be presented as a name/value pair. Issuance rules refer to rules used to determine whether a claim should be generated. Collections of issuance rules are referred to as an issuance policy.

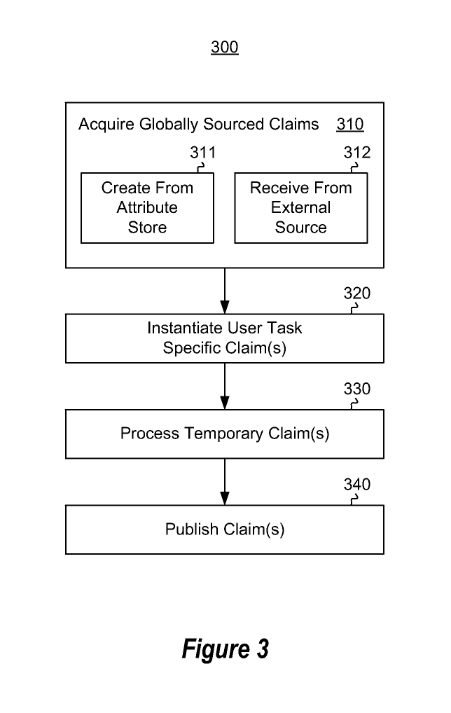

Issuance policies can become quite complex, and issuance rules can end up interfering with each other in unanticipated ways. The described pipeline is a structured operation pipeline that may be modeled on a user task, thereby providing a framework in which a user can easily author an issuance statement. The user task is based on an issuance statement, which is a collection of issuance rules that are collected and structured in a manner that the issuance statement is self-contained, and thus order independent. The issuance rules themselves are abstracted away from the issuance statement author. The various stages 210, 220, 230 and 240 of the pipeline 200 may be implemented on a single computing system, or perhaps on different computing systems, or perhaps only some are implemented on the computing system. The pipeline 200 of FIG. 2 will now be described with frequent reference to FIG. 3, which illustrates a flowchart of a method 300 for operating the pipeline. Components of FIG. 2 are labeled in the 200's, whereas acts in the method of FIG. 3 are labeled in the 300's.

An initialization stage 210 acquires a set of one or more global sourced claims (act 310). The globally sourced claims are claims that can be used by any issuance statement that has access to the globally sourced claims. To illustrate the broader principles described herein, a particular scenario will now be outlined and used throughout this description. In this scenario, a user task is to issue claims representing the role of the user. The issuance rule author wants to source all group membership claims from the authenticated user, but filter such that only memberships to user group “Managers” and “Purchasers” be sent. Thus, the initialization stage 210 will acquire the set of all group membership claims for the authenticated user.

In one embodiment, the initialization stage 210 creates at least a portion of the set of one or more globally sourced claims from an attribute store 211 (act 311). For example, the initialization stage 210 might query an attribute store for all group memberships associated with the authenticated user, and in response receive a list of group memberships associated with the authenticated user. The initialization stage 210 may then create the globally sourced claims from the attributes. The following globally sourced claim is an example of how a claim that specifies an attribute associated with the user could be represented:

c:[Type==
“http://schemas.microsoft.com/ws/2008/06/identity/claims/
windowsaccountname”] => add ( store = “Active Directory” ,
types = (“urn:733eff54-7587-41c8-983f-f801defa1a41”) ,
query = “;tokenGroups;{0}”, param = c.Value );

Here, the “urn” value makes the claim global in that it can be consumed by any issuance statement. There may be multiple of such globally sourced claims, perhaps one for each obtained role attribute received from the attribute store. For instance, the “urn” is the claim identifier. Thus, the fact that the identifier is shared globally amongst all issuance statements defines it global scope.

As an alternative, or in addition, the initialization stage 210 may acquire the global sourced claim(s) by receiving one or more of them already as a global sourced claim from an external claim source that is external to the pipeline (act 312).

A pre-processing stage 220 instantiates a set of user task specific claims derived from a set of one or more globally sourced claims (act 320). The user task specific claims are used internal to the pipeline, and thus any manipulations to the user task specific claims have no effect on the globally sourced claims as they are interpreted outside of the pipeline 200. In the scenario, this is accomplished for each of the claims by changing the type of identifier of the claim to denote it is a different claim and has a scope that is strictly internal to the pipeline. This results in a different “urn” value being generated for each of the claims. As an example, the above claim may be changed to the following:

c:[Type == “urn:733eff54-7587-41c8-983f-f801defa1a41”] => add
( type = “urn:908bafa9-8b59-41a2-9141-f78deabfcec4”, value = c.value );

Note how the “urn” value has changed. Now, the claim may only be manipulated within the pipeline 200, with no effect on the corresponding globally sourced claim.

A processing stage 230 manipulates the set of one or more user task specific claims instantiated by the pre-processing stage by generating a set of one or more temporary claims (act 330) wherein the processing stage 230 generates the set of one or more temporary claims by applying issuance rules to the set of one or more user task specific claims. In FIG. 2, there are two issuance rules 231 and 232 illustrated. However, the ellipses 233 represent that there may be other numbers of issuance rules, and that the number of issuance rules may be edited using the user interface 250.

As an example, the processing stage 230 may manipulate the set of one or more user task specific claims by filtering the set of one or more user task specific claims. As an example, the following two filtering issuance rules might be generated using processing stage 230 in which case each filtering rule is applied in sequence to each user task specific claim.

```
c:[Value == “Managers”, Type == “urn:908bafa9-8b59-41a2-9141-
f78deabfcec4”]
    => add ( type = “urn:5b12a7a4-8806-45c7-b1f3-62e19c5d102a”,
    value = c.value );
c:[Value == “Purchasers”, Type == “urn:908bafa9-8b59-41a2-9141-
f78deabfcec4”]
    => add ( type = “urn:5b12a7a4-8806-45c7-b1f3-62e19c5d102a”,
    value = c.value );
```

Alternatively or in addition to filtering, the issuance rules may specify a transformation that is to occur on each in the set of one or more user task specific claims. The resulting issuance statements are self-contained in that all information necessary to issue a claims ranging from the source, manipulation operations and output is contained within the realms of the pipeline 200. As a result of being self-contained, the issuance statements are no longer sensitive to the order in which they are executed.

A publication stage 240 issues the set of one or more temporary claims in a predetermined final output claim type (act 340) in preparation for claim issuance. The following is an example of a published claim in the user task example used throughout:

c:[ Type == “urn:5b12a7a4-8806-45c7-b1f3-62e19c5d102a” ] => issue
( type = “http://schemas.microsoft.com/ws/2008/06/identity/claims/role” ,
Value = c.Value );

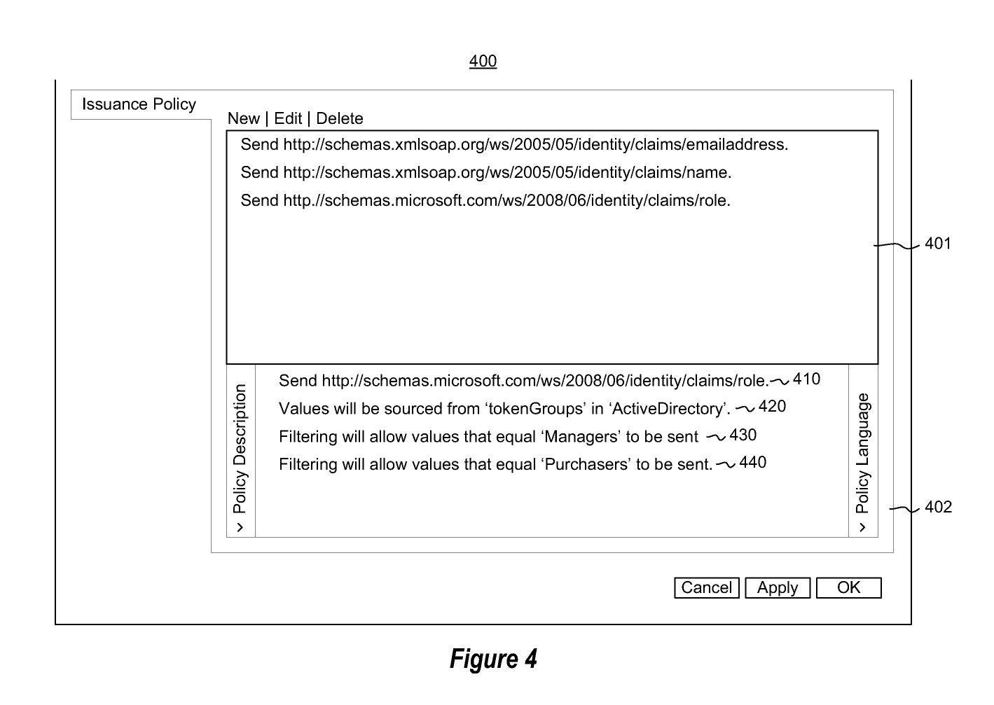

The user interface 250 manipulates the issuance statements direction (and thereby indirectly the issuance rules) used to process the set of one or more user task specific claims. FIG. 4 illustrates one example user interface 400 in which the user may specify issuance statements using natural language. In window 401, the user may specify the use statements in natural language. In this case, the user has selected to send role attributes. Note, for example, how the third issuance statement in the window 401 is highlighted. If the pipeline 200 is implemented by the computing system 100 of FIG. 1, the user interface 400 might appear on the display 112.

In window 402, the issuance rules associated with the selected issuance statement in window 401 are outlined in natural language. Line 410 summarizes the user's selection in window 401. Line 420 specifies that the claim values are to be sourced from the attribute “tokenGroups” from the “ActiveDirectory” attribute store. Furthermore, lines 430 and 440 specify the processing stage rules themselves, each using natural language.

Accordingly, the principles described herein permit for a framework based mechanism for formulating claims in a desired format. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer storage media having thereon computer-executable instructions that are structured such that, when executed by one or more processors of a computing system, the computing system is caused to instantiate a claim processing pipeline that comprises the following:
an initialization stage that acquires a set of one or more globally sourced claims that can be used by any issuance statement;
a processing stage that manipulates a set of one or more user task specific claims that are derived from the set of one or more globally source claims, the set of one or more user task specific claims being manipulated by generating a set of one or more temporary claims, wherein the processing stage generates the set of one or more temporary claims by applying a plurality of issuance rules to the set of one or more user task specific claims; and
a publication stage that issues the set of one or more temporary claims in an issuance format.

2. The computer program product in accordance with claim 1, wherein the pipeline further comprises the following:
a pre-processing stage that instantiates the set of user task specific claims derived from the set of one or more global sourced claims.

3. The computer program product in accordance with claim 1, wherein the initialization stage creates at least a portion of the set of one or more globally sourced claims from an attribute store.

4. The computer program product in accordance with claim 3, wherein the initialization stage also receives a portion of the set of one or more globally sourced claims from a source external to the pipeline.

5. The computer program product in accordance with claim 1, further comprising:
a user interface that allows a user to manipulate the plurality of issuance statements.

6. The computer program product in accordance with claim 1, wherein the plurality of issuance statements are self-contained.

7. The computer program product in accordance with claim 6, wherein the plurality of issuance statements are order-independent.

8. The computer program product in accordance with claim 1, wherein the plurality of issuance statements are order-independent.

9. The computer program product in accordance with claim 1, wherein the processing stage manipulates the set of one or more user task specific claims instantiated by filtering the set of one or more user task specific claims.

10. The computer program product in accordance with claim 9, wherein the processing stage manipulates the set of one or more user task specific claims instantiated by transforming the set of one or more user task specific claims.

11. The computer program product in accordance with claim 1, wherein the processing stage manipulates the set of one or more user task specific claims instantiated by transforming the set of one or more user task specific claims.

12. The computer program product in accordance with claim 1, wherein the processing stage does not require information from outside the pipeline, except the one or more user task specific claims, in order to perform the manipulation.

13. A computerized method for processing claims in a pipeline, the method comprising:
in an initialization stage, an act of creating at least a portion of the set of one or more globally sourced claims that can be used by any user task;
in a processing stage, an act of manipulating a set of one or more user task specific claims that are derived from the set of one or more globally source claims, the set of one or more user task specific claims being manipulated by applying a plurality issuance rules to the set of one or more user task specific claims; and
in a publication stage, an act of issuing the set of one or more temporary claims in a predetermined issuance claim format.

14. The method in accordance with claim 13, further comprising the following:
in a pre-processing stage, an act of instantiating the set of one or more user task specific claims.

15. The method in accordance with claim 13, wherein the initialization stage receives a portion of the set of one or more globally sourced claims from a source external to the pipeline.

16. The method in accordance with claim 15, wherein the initialization stage creates at least a portion of the set of one or more globally sourced claims from an attribute store.

17. The method in accordance with claim 14, wherein the initialization stage creates at least a portion of the set of one or more globally sourced claims from an attribute store.

18. The method in accordance with claim 14, wherein the initialization stage, processing stage, and the publication stage are on the same computing system.

19. The method in accordance with claim 14, wherein the processing stage does not require information from outside the pipeline, except the one or more user task specific claims, in order to perform the manipulation.

20. A computer program product comprising one or more computer storage media having thereon computer-executable instructions that are structured such that, when executed by one or more processors of a computing system, the computing system is caused to instantiate a claim processing pipeline that comprises the following:
an initialization stage that acquires the set of one or more globally sourced claims, wherein the initialization stage creates at least a portion of the set of one or more global sourced claims from an attribute store;
a pre-processing stage that instantiates a set of user task specific claims derived from a set of one or more global sourced claims that can be used by any user task;
a processing stage that manipulates the set of one or more user task specific claims instantiated by the pre-processing stage by generating a set of one or more temporary claims, wherein the processing stage generates the set of one or more temporary claims by applying a plurality of issuance rules to the set of one or more user task specific claims, wherein the plurality of issuance rules is order independent in that the same result is achieved regardless of the order in which the issuance rules are applied; and
a publication stage that issues the set of one or more temporary claims in a predetermined output claim type.
